(19) United States
(12) Patent Application Publication
(10) Pub. No.: US 2009/0237707 A1
(43) Pub. Date: Sep. 24, 2009

(54) IMAGE TRANSMISSION APPARATUS, FACSIMILE DEVICE, COMPUTER READABLE MEDIUM STORING PROGRAM, IMAGE TRANSMISSION METHOD, AND COMPUTER DATA SIGNAL

(75) Inventor: Noriko Seto, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/203,526

(22) Filed: Sep. 3, 2008

(30) Foreign Application Priority Data
Mar. 21, 2008 (JP) 2008-073042

(51) Int. Cl. G06F 3/12

(52) U.S. Cl. 358/1.15

(57) ABSTRACT

An image transmission apparatus includes an address instruction unit that is configured to instruct an address of a destination, a transmission interruption instruction unit that is configured to, after transmission to the address of the destination instructed by the address instruction unit is instructed, instruct interruption of the transmission, and a retransmission instruction unit that is configured to, when the transmission is instructed to be interruption by the transmission interruption instruction unit, instruct transmission of a newly fetched image in a state that the address instructed by the address instruction unit is maintained.

### CROSS-REFERENCE TO RELATED APPLICATIONS

This application is based on and claims priority under 35 USC 119 from Japanese Patent application No. 2008-073042 filed Mar. 21, 2008.

### BACKGROUND

1. Technical Field

The present invention relates to an image transmission apparatus, a facsimile device, a computer readable medium storing a program, an image transmission method and computer data signal.

### SUMMARY

According an aspect of the present invention, there is provided an image transmission apparatus including: an address instruction unit that is configured to instruct an address of a destination; a transmission interruption instruction unit that is configured to, after transmission to the address of the destination instructed by the address instruction unit is instructed, instruct interruption of the transmission; and a retransmission instruction unit that is configured to, when the transmission is instructed to be interruption by the transmission interruption instruction unit, instruct transmission of a newly fetched image in a state that the address instructed by the address instruction unit is maintained.

### BRIEF DESCRIPTION OF THE DRAWINGS

Exemplary embodiments of the present invention will be described in detail based on the following figures, wherein:

FIG. 1 is a view exemplifying the constitution of an image transmission and reception system according to the present invention;

FIG. 2 is a view exemplifying the hardware constitution of an image transmission and reception apparatus shown in FIG. 1;

FIG. 3 is a view exemplifying the constitution of a controller shown in FIG. 2;

FIG. 4 is a view showing the constitution of a UI unit shown in FIG. 2;

FIG. 5 is a view showing the constitution of an image transmission program performed by the image transmission and reception apparatus;

FIGS. 6A and 6B are views showing a screen which is displayed on a screen display (FIG. 4) of the UI unit;

FIGS. 7A to 7C are views showing a screen displayed on the screen display;

FIG. 8 is a flowchart showing the processing of the image transmission program (S10);

FIG. 9 is a view showing the constitution of an image transmission program performed by the image transmission and reception apparatus;

FIGS. 10A to 10C are views showing a screen which is displayed on a screen display (FIG. 4) of the UI unit;

FIGS. 11A to 11C are views showing a screen displayed on the screen display;

FIG. 12 is a flowchart showing the processing of the image transmission program (S20);

FIG. 13 is a view showing the constitution of an image transmission program performed by the image transmission and reception apparatus;

FIG. 14 is an after-document-change address input screen which the UI controller displays in place of an after-document-change address confirmation screen shown in FIG. 7C; and

FIG. 15 is a flowchart showing the processing of the image transmission program (S30).

### DETAILED DESCRIPTION

### [History of the Present Invention]

First of all, for facilitating the understanding of the image transmission apparatus according to the present invention, the history of the present invention is explained prior to the explanation of the exemplary embodiments of the present invention.

A user can, in transmitting a document (an image) using a facsimile device, interrupt the transmission when the user becomes aware of an error of an address after starting the transmission.

When the transmission is interrupted in this manner, the user newly inputs the address and transmits the document again.

However, when the user finds an error on a document to be transmitted, for example, the user also interrupts the transmission, replaces the document with a desired document, newly inputs the address, and transmits the document again.

That is, even when the user interrupts the transmission because of a cause other than the error of the address, the user has to input the address again.

The present invention has been made by focusing on such a point, and is configured to realize easy retransmission of the document when the transmission is interrupted due to a cause other than an address.

### First Exemplary Embodiment

An image transmission and reception system 1 is explained hereinafter as a first exemplary embodiment of the present invention.

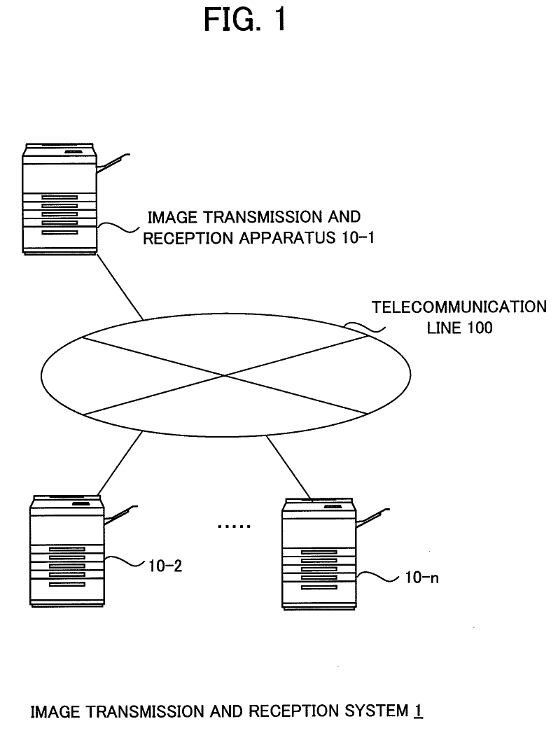

FIG. 1 is a view illustrating the constitution of the image transmission and reception system 1 according to the present invention.

As shown in FIG. 1, image transmission and reception apparatuses 10-1 to 10-n are connected to each other via a telecommunication network 100 such as a public communication network or the Internet.

Here, symbol n indicates an integer number equal to or more than 1.

Further, to specify any one of plural constitutional parts such as the image transmission and reception apparatuses 10-1 to 10-n, such a constitutional part may be simply referred to as the image transmission and reception apparatus 10.

Further, in the following respective drawings, the same symbols are given to substantially-identical constitutional parts and processing.

An image transmission and reception apparatus 10-i (1≦i≦n) transmits image data of a facsimile document read by an image reading device such as a scanner to the image transmission and reception apparatuses 10-j (1≦j≦n, i≠j) which constituted the other party via the telecommunication network 100.

Further, the image transmission and reception apparatus 10-i may simultaneously transmit the same image data to the plural the image transmission and reception apparatuses 10-j, 10-k (1≦k≦n, i≠j≠k) or the like.

Further, the image transmission and reception apparatus 10-i outputs the image based on the image data received via the telecommunication network 100.

As specific examples of the image transmission and reception apparatus 10, various types of devices including a facsimile device, a printer having a facsimile function and a copying function are considered.

### [Hardware Constitution]

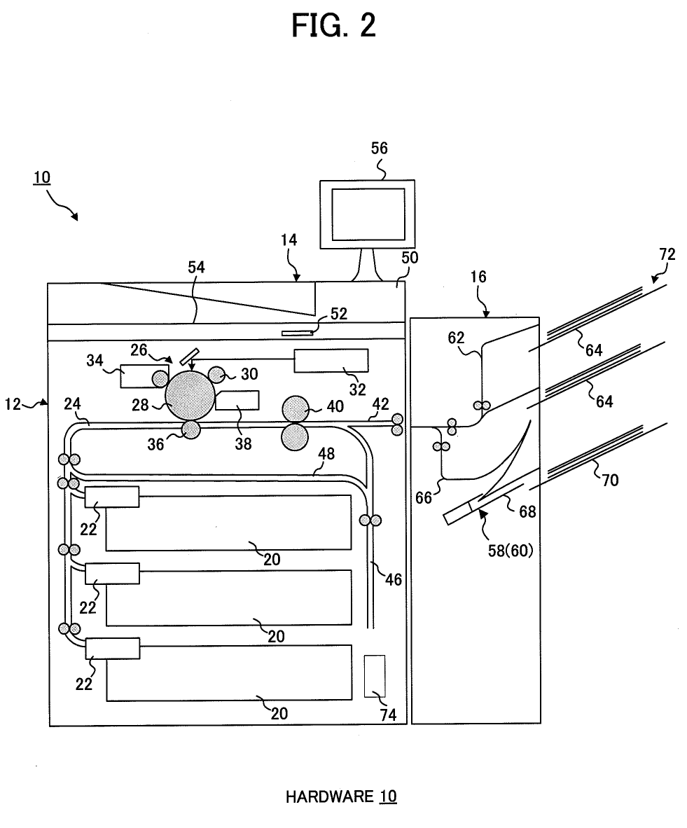

FIG. 2 is a view showing the constitution of the image transmission and reception apparatus 10 according to the exemplary embodiments of the present invention.

As shown in FIG. 2, the image transmission and reception apparatus 10 includes an image forming device body 12, an image reading device 14 and a post-processing device 16.

The image forming device body 12 includes plural paper supply parts 20 (in three stages, for example), and each paper supply part 20 is provided with a feeder head 22.

The plural the paper supply parts 20 respectively supplies sheets which have the same size and are arranged in the same direction, or sheets which have same sizes and are arranged in the different directions, or sheets which have different sizes and are arranged in the same directions, or sheets which have different sizes and are arranged in the different directions.

For example, three stages of the paper supply parts 20 supply the sheets of the different sizes of A3, A4 and B5 respectively.

Accordingly, the sheets are supplied to an image forming part 26 from the selected paper supply part 20 by operating the feeder head 22 by way of a paper conveying passage 24.

In such a manner, the paper supply parts 20 constitute a recording medium supply unit.

The image forming part 26 adopts xerography, for example, and forms an image on a sheet conveyed through the paper conveying passage 24.

To be more specific, the image forming part 26 includes an image carrier 28, a charging roller 30 which uniformly charges a surface of the image carrier 28, a laser writing device 32 which writes a latent image on the image carrier 28, a developing device 34 which develops the latent image written on the image carrier 28, a transfer roller 36 which transfers a developed toner image to the sheet, a cleaner 38 which removes residual toner, and a fixing device 40 which fixes the toner image to the sheet.

Accordingly, the surface of the image carrier 28 is uniformly charged by the charging roller 30, the latent image is formed by the laser writing device 32, the latent image is developed by the developing device 34, the developed toner image is transferred to the sheet by the transfer roller 36 and is fixed by the fixing device 40, and the sheet is outputted from a paper discharging passage 42 to the post-processing device 16.

Due to such a constitution, the image forming part 26 constitutes an image forming part.

When duplex printing is set, the sheet which has one surface on which an image is fixed by the fixing device 40 is fed to a reversing device 46 from the paper discharging passage 42, is reversed in the reversing device 46, is fed to a paper reversing passage 48, is returned to the paper conveying passage 24 again, and is fed to the image forming part 26 for printing an image on the other surface of the sheet.

The image reading device 14 includes an automatic document feeder 50 such as an ADF (Auto Document Feeder), and a scanner 52 which scans a document fed from the automatic document feeder 50.

The document is fed to a platen 54 by the automatic document feeder 50 and an image on the document is read on the platen 54 by the scanner 52.

When copying is set by the image transmission and reception apparatus 10, the image which is read by the image reading device 14 is printed and copied by the image forming device body 12.

The post-processing device 16 includes a sorter 72, a stapler 58 and a puncher 60, for example.

The sorter 72 guides the printed sheets outputted from the image forming device body 12 to distribution passages 62 and distributes the sheets to plural bins 64.

The stapler 58 guides the printed sheets outputted from the image forming device body 12 to a compiler tray 68 by way of a conveying passage 66, fixes a bundle of the sheets stacked on the compiler tray 68 one after another at a predetermined position with needles, and the bundle of the sheets is discharged to a stacker 70.

Due to such a constitution, the stapler 58 constitutes a binding unit for binding the sheets.

The puncher 60 punches holes in the bundle of the sheets stacked on the compiler tray 68 at predetermined positions and the bundle of the sheets is discharged to the stacker 70.

An input/display (UI) device 56 includes a touch panel, for example, and is mounted on an upper portion of the image forming device body 12. The UI device 56 receives an input from a user and selects and displays contents of processing performed by the image forming device body 12, the image reading device 14 and the post-processing device 16.

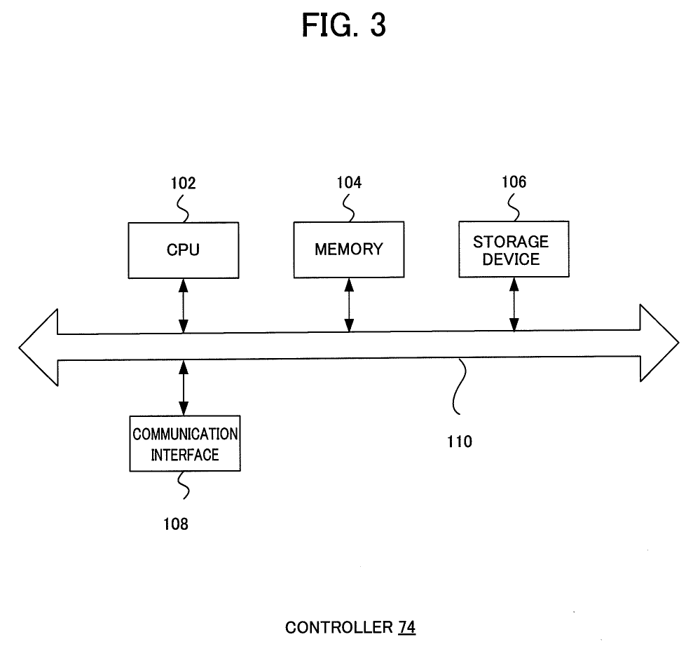

FIG. 3 is a view illustrating the constitution of a controller 74 shown in FIG. 2.

As shown in FIG. 3, the controller 74 includes a CPU 102, a memory 104, a storage device 106 such as a hard disc drive (HDD), a communication interface (IF) 108 through which data is transmitted to and received from an external computer.

These constitutional elements are connected with each other via a system bus 110.

Due to such a constitution, the controller 74 controls the image transmission and reception apparatus 10.

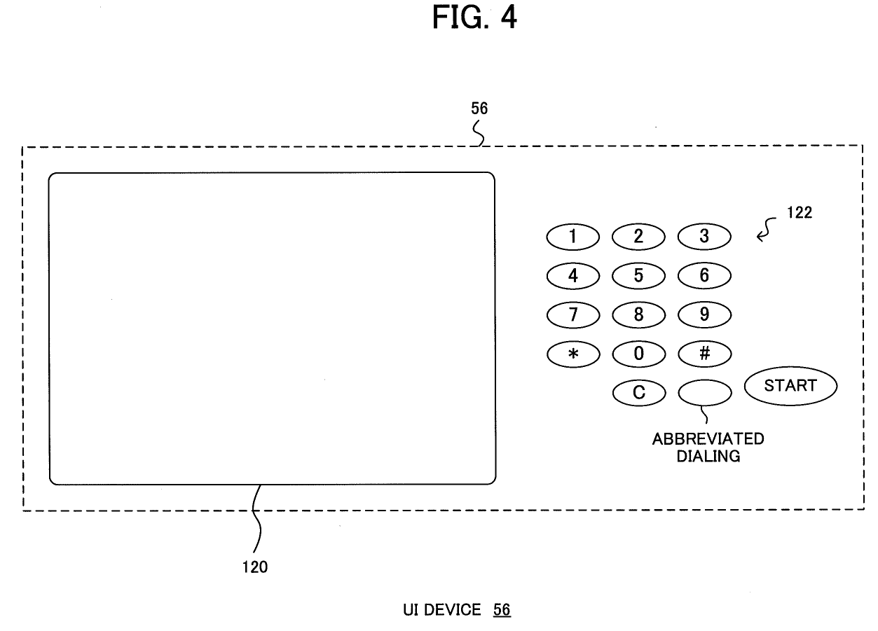

FIG. 4 is a view showing the constitution of the UI device 56 shown in FIG. 2.

As shown in FIG. 4, the UI device 56 includes a screen display 120 which is constituted of a touch panel displayed on the screen display 120 and a liquid crystal display, a group of operation buttons 122 such as a numeric keypad, a clear button (C), an abbreviated dialing button and a start button.

The user can operate the touch panel and the group of operation buttons 122 to perform inputting of an address of the destination, starting of transmission of a document, interrupting of transmission of the document and the like.

### [Image Transmission Program 2]

Hereinafter, an image transmission program 2 is explained.

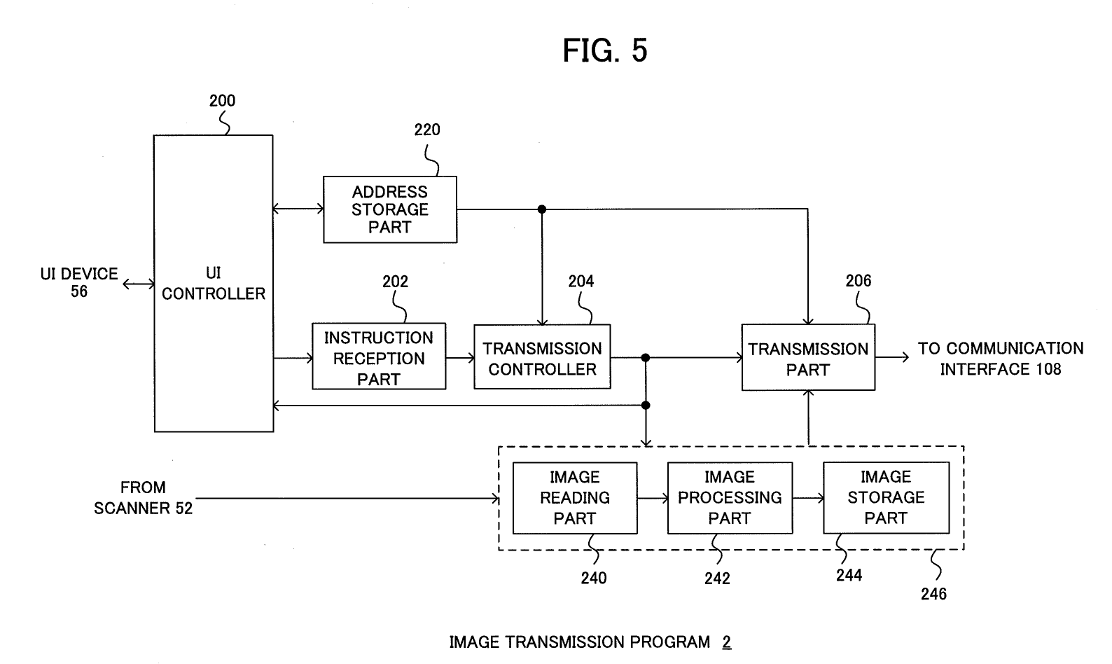

FIG. 5 is a view showing the constitution of the image transmission program 2 executed in the image transmission and reception apparatus 10.

As shown in FIG. 5, the image transmission program 2 is constituted of a UI controller 200, an instruction reception part 202, a transmission controller 204, a transmission part 206, an address storage part 220 and an image management part 246.

The image management part 246 is constituted of an image reading part 240, an image processing part 242 and an image storage part 244.

The image transmission program 2 is, for example, stored in the memory 104, is supplied to the image transmission and reception apparatus 10, and is executed based on an operation system (not shown in the drawings) of the image transmission and reception apparatus 10 by specifically making use of hardware resources of the image transmission and reception apparatus 10 (respective programs described hereinafter being also constituted in the same manner as described above).

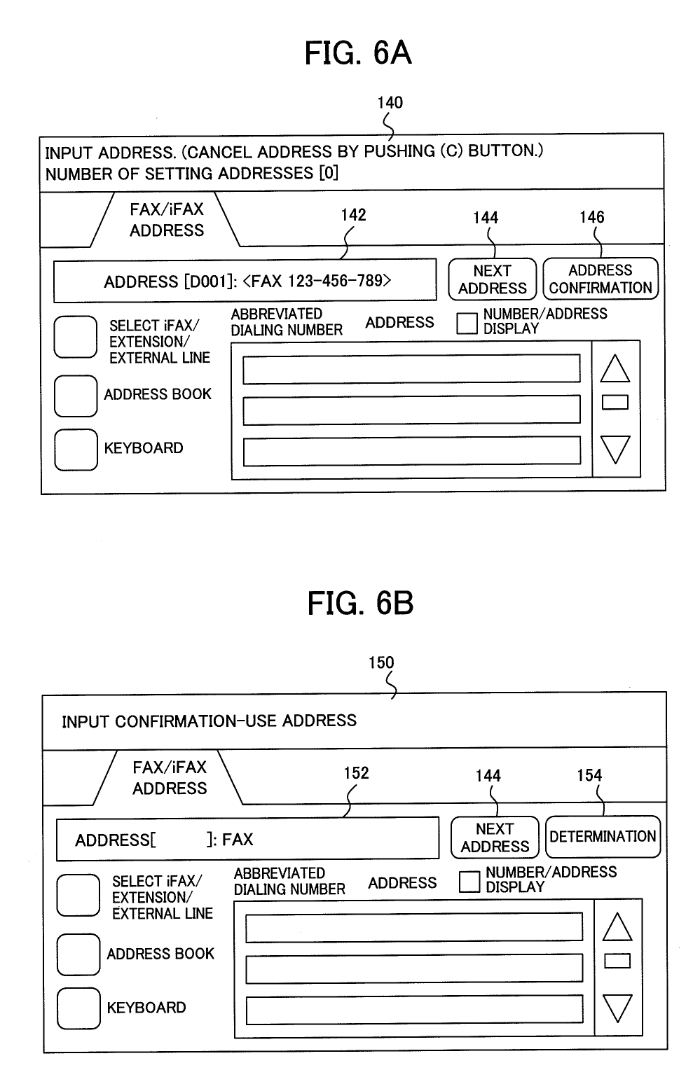

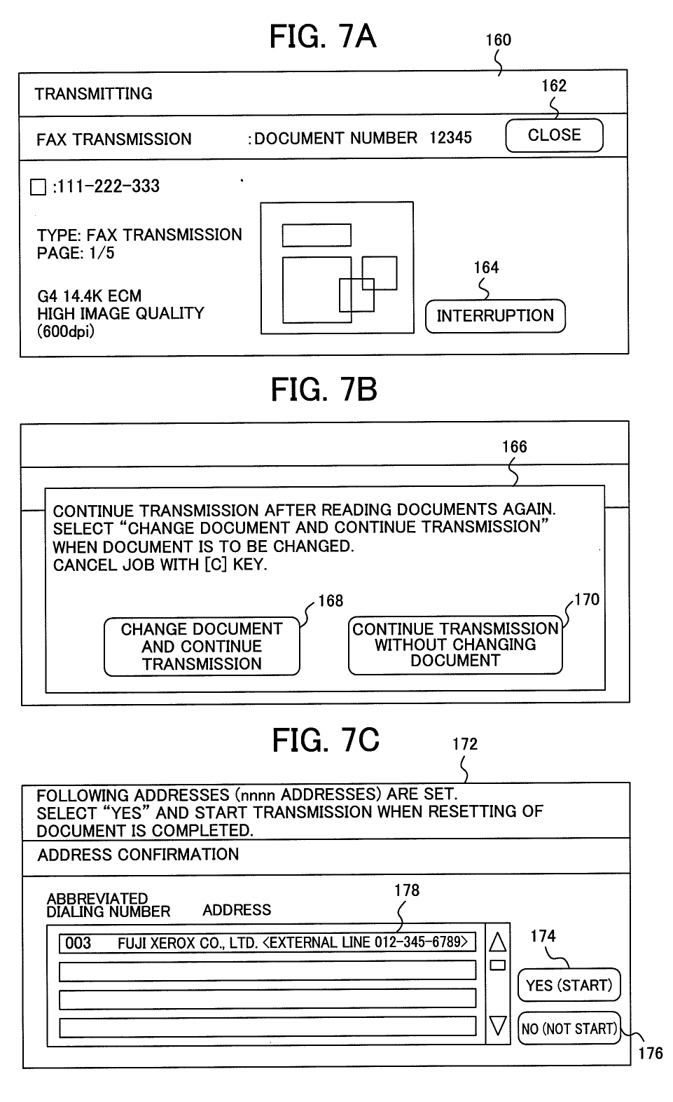

The UI controller 200 displays an image which is described later in conjunction with FIG. 6 and FIG. 7 on the screen display 120.

First of all, a screen which the UI controller 200 displays on the screen display 120 is explained in conjunction with FIG. 6 and FIG. 7.

FIG. 6A and FIG. 6B are views showing screens which are displayed on the screen display 120 of the UI device 56. FIG. 6A shows an address input screen (address instruction unit (address reception unit)) which allows the user to input an address, and FIG. 6B shows an address input screen for confirmation (address instruction unit (address confirmation reception unit)) which allows the user to confirm inputting of the address.

FIG. 7A to FIG. 7C are views showing screens which are displayed on the screen display 120. FIG. 7A shows a screen (transmission screen) which displays a state that a document is being transmitted, FIG. 7B shows an interruption screen displayed when an interruption button 164 shown in FIG. 7A is pushed, and FIG. 7C shows a screen (address confirmation screen after changing the document) displayed when a document change button 168 shown in FIG. 7B is pushed.

As shown in FIG. 6A, the address input screen includes a status display region 140, an address display region 142, a next address button 144, an address confirmation input button 146 and the like.

The status display region 140 indicates that the display screen is an address input screen.

The address display region 142 displays an address inputted by the user.

When the user pushes the next address button 144, the screen is shifted to a screen (not shown in the drawings) which allows the user to input a new address.

When the user pushes the address confirmation input button 146, the screen is shifted to a confirmation-use address input screen shown in FIG. 6B.

As shown in FIG. 6B, the confirmation-use address input screen includes the next address button 144, a status display region 150, a determination-use address display region 152, a determination button 154 and the like.

The status display region 150 indicates that a confirmation-use display screen is the address input screen.

The address display region for determination 152 displays the address (confirmation-use address information) inputted for confirmation by the user.

When the user pushes the determination button 154, the inputted confirmation-use address information is determined, and the screen is shifted to the address input screen shown in FIG. 6A.

As shown in FIG. 7A, a transmission screen includes a status display region 160, a closing button 162, an interruption button 164 (transmission interruption instruction unit) and the like.

The status display region 160 indicates that a display screen is the transmission screen.

When the user pushes the closing button 162, the transmission screen is closed.

When the user pushes the interruption button 164, the screen is shifted to the interruption screen shown in FIG. 7B.

As shown in FIG. 7B, the interruption screen includes a status display region 166, a document change button 168 (retransmission instruction unit), a continuation button 170 and the like.

The status display region 166 indicates that a display screen which is the interruption screen, and also displays instructions for the user.

The document change button 168 is a button which is pushed by the user when the user wants to read the document again and to continue the transmission while maintaining the inputted address.

When the user pushes the document change button 168, the screen is shifted to a document change confirmation screen shown in FIG. 7C.

The continuation button 170 is a button for continuing the transmission. When the user pushes the continuation button 170, the transmission is started again from a point of time that the transmission is interrupted, and the screen is shifted to the transmission screen shown in FIG. 7A.

As shown in FIG. 7C, the address confirmation screen after changing the document includes a status display region 172, a start button 174, a cancel button 176, an address confirmation region 178 and the like.

The status display region 172 indicates that the display screen which is the address confirmation screen after changing the document, and also displays instructions for the user.

When the user pushes the start button 174 after changing the document, the document is read again and the transmission is continued, and the screen is shifted to the transmission screen shown in FIG. 7A.

When the user pushes the cancel button 176, the screen is shifted to the interruption screen shown in FIG. 7B.

The address confirmation region 178 is displayed for confirming the address which is inputted by the user.

The UI controller 200 (FIG. 5) displays the screens shown in FIG. 6A, 6B and FIG. 7A, 7B, 7C on the screen display 120 of the UI device 56.

Further, the UI controller 200 outputs the address information which is inputted via the UI device 56 to an address storage part 220.

Further, the UI controller 200 outputs an operation instruction inputted by the user with the use of the group of operation buttons 122 of the UI device 56, the touch panel of the screen display 120 or the like to an instruction reception part 202.

Further, the UI controller 200 displays a screen based on a control by a transmission controller 204 on the screen display 120.

To be more specific, the UI controller 200 displays the address input screen shown in FIG. 6A, displays the address information which is inputted by the user with the use of the group of operation buttons 122 or the like on the address display region 142, and outputs the address information to the address storage part 220.

When the user pushes the address confirmation input button 146, the UI controller 200 displays the confirmation-use address input screen shown in FIG. 6B, displays an address inputted by the user for confirmation (confirmation-use address information) on the confirmation-use address display region 152, and outputs the address information to the address storage part 220.

When the user pushes a determination button 154 of the confirmation-use address input screen shown in FIG. 6B, the UI controller 200 determines whether or not the address information stored in the address storage part 220 and the confirmation-use address information agree with each other. When both address information agree with each other, the UI controller 200 displays the address input screen shown in FIG. 6A, while when the address information do not agree with each other, the UI controller 200 executes processing for asking the user to input the confirmation-use address again or the like.

When the user pushes the start button from the group of operation buttons 122 (FIG. 4), the UI controller 200 outputs the received transmission instruction to the instruction reception part 202 and, in accordance with control by the transmission controller 204, displays the address input screen shown in FIG. 6A or the transmission screen shown in FIG. 7A.

Further, when the user pushes the interruption button 164 shown in FIG. 7A, the UI controller 200 outputs the received operation interruption instruction to the instruction reception part 202, and displays the interruption screen shown in FIG. 7B.

When the user pushes the document change button 168 shown in FIG. 7B, the UI controller 200 displays the document change confirmation screen shown in FIG. 7C.

When the user pushes the continuation button shown in FIG. 7B, the UI controller 200 outputs an instruction (continuation instruction) indicative of continuation of the transmission to the instruction reception part 202, and displays the transmission screen shown in FIG. 7A.

Further, when the user pushes a (C) key on the interruption screen shown in FIG. 7B, the UI controller 200 outputs an instruction (cancellation instruction) indicative of cancellation of the transmission to the instruction reception part 202.

Further, when the user pushes the start button 174 shown in FIG. 7C, the UI controller 200 outputs an instruction (after-document-change continuation instruction) indicative of the continuation of transmission after changing the received document to the instruction reception part 202, and displays the transmission screen shown in FIG. 7A.

Further, when the user pushes the cancellation button 176 shown in FIG. 7C, the UI controller 200 displays the interruption screen shown in FIG. 7B.

The address storage part 220 stores the address information and the confirmation-use address information inputted from the UI controller 200.

The instruction reception part 202 outputs the instruction inputted from the UI controller 200 to the transmission controller 204.

To be more specific, to the transmission controller 204, the instruction reception part 202 outputs the transmission start instruction which is inputted when the start button (FIG. 4) is pushed, the interruption instruction which is inputted when the interruption button 164 (FIG. 7A) is pushed, the after-document-change continuation instruction which is inputted when the start button 174 (FIG. 7C) is pushed, the continuation instruction which is inputted when the continuation button 170 (FIG. 7B) is pushed, and the cancellation instruction which is inputted when the (C) key (FIG. 7B) is pushed.

The transmission controller 204 controls the UI controller 200, the transmission part 206 and the image management part 246, in response to the instruction which is inputted from the instruction reception part 202.

To be more specific, the transmission controller 204 confirms, when the transmission start instruction is inputted, whether or not the address information and the confirmation-use address information are stored in the address storage part 220. When the both are stored in the address storage part 220, the transmission controller 204 allows the image management part 246 to start reading of an image and the transmission part 206 to start the transmission of the image information. When not both are stored in the address storage part 220, the transmission controller 204 allows the UI controller 200 to display the address input screen (FIG. 6A).

Further, the transmission controller 204 allows, when the interruption instruction is inputted, the image management part 246 to interrupt reading of the image and the transmission part 206 to interrupt the transmission of the image information.

Further, the transmission controller 204 allows, when the after-document-change continuation instruction is inputted, the image management part 246 to start reading of an image after performing initializing processing and the transmission part 206 to start the transmission of the image information.

Further, the transmission controller 204 allows, when the continuation instruction is inputted, the image management part 246 to start reading of an image again and the transmission part 206 to start the transmission of the image information again.

Further, the transmission controller 204 allows, when the cancellation instruction is inputted, the image transmission program 2 to perform the initializing processing.

The transmission part 206 transmits, in accordance with the control by the transmission controller 204, the image information which is inputted from the image storage part 244 of the image management part 246 to the telecommunication network 100 based on the address information stored in the address storage part 220 via the communication IF 108.

The image reading part 240 of the image management part 246 reads, in accordance with the control of the transmission controller 204, image data which is inputted from the scanner 52 and outputs the image data to the image processing part 242.

The image processing part 242 applies image processing such as filter processing or binarization processing to the image data which is inputted from the image reading part 240, and outputs the image data to the image storage part 244.

The image data to which the image processing is applied is inputted from image processing part 242 to and stored in the image storage part 244, and in accordance with the control by the transmission controller 204, the image storage part 244 outputs the image data to the transmission part 206.

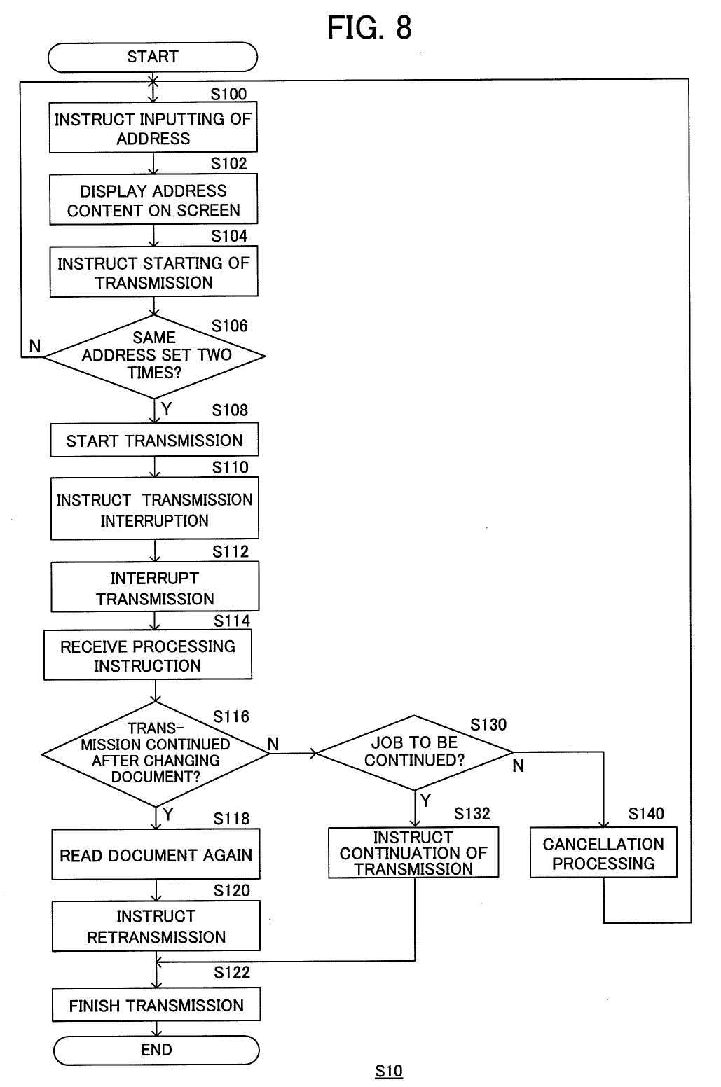

The processing of the image transmission program 2 explained above is further explained in conjunction with FIG. 8.

FIG. 8 is a flowchart showing the processing of the image transmission program 2 (S10).

As shown in FIG. 8, in step 100 (S100), the UI controller 200 displays the address input screen shown in FIG. 6A and asks the user to input an address.

In step 102 (S102), the UI controller 200 displays the address inputted by the user on the address display region 142 (FIG. 6A).

In step 104 (S104), the transmission controller 204 receives a transmission start instruction which is inputted when the user pushes the start button from the group of operation buttons 122.

In step 106 (S106), the transmission controller 204 determines whether or not the address information and the confirmation-use address information are stored in the address storage part 220.

When the address information and the confirmation-use address information are stored in the address storage part 220, the processing advances to step S108, while when the information are not stored in the address storage part 220, the processing returns to step S100.

In step 108 (S108), the transmission controller 204 allows the image management part 246 to start reading of the image and allows the transmission part 206 to start the transmission.

In step 110 (S110), the transmission controller 204 receives an interruption instruction by way of the transmission screen shown in FIG. 7A.

Instep 112 (S112), the transmission controller 204 allows the image management part 246 to interrupt reading of the image and allows the transmission part 206 to interrupt the transmission.

In step 114 (S114), the transmission controller 204 receives an after-document-change continuation instruction, a continuation instruction or a cancellation instruction by way of the interruption screen shown in FIG. 7B or the document change confirmation screen shown in FIG. 7C.

In step 116 (S116), the transmission controller 204 determines whether or not the received instruction is the after-document-change continuation instruction.

When the received instruction is the after-document-change continuation instruction, the processing advances to step S118, while when the received instruction is not the after-document-change continuation instruction, the processing advances to step S130.

Instep 118 (Sl18), the transmission controller 204 allows the image management part 246 to start the reading of the image after performing the initializing processing.

Instep 120 (S120), the transmission controller 204 allows the transmission part 206 to start the transmission.

In step 122 (S122), the image transmission program 2 finishes the transmission processing.

In step 130 (S130), the transmission controller 204 determines whether or not the received instruction is the continuation instruction.

When the received instruction is the continuation instruction, the processing advances to the step S132, while when the received instruction is not the continuation instruction, the processing advances to the step S140.

In step 132 (S132), the transmission controller 204 allows the image management part 246 to restart the reading of the image, and allows the transmission part 206 to restart the transmission.

In step 140 (S140), the transmission controller 204 allows the image transmission program 2 to perform the initializing processing.

### Second Exemplary Embodiment

An image transmission program 3 is explained hereinafter as the second exemplary embodiment of the present invention.

### [Image Transmission Program 3]

The image transmission program 3 is explained hereinafter.

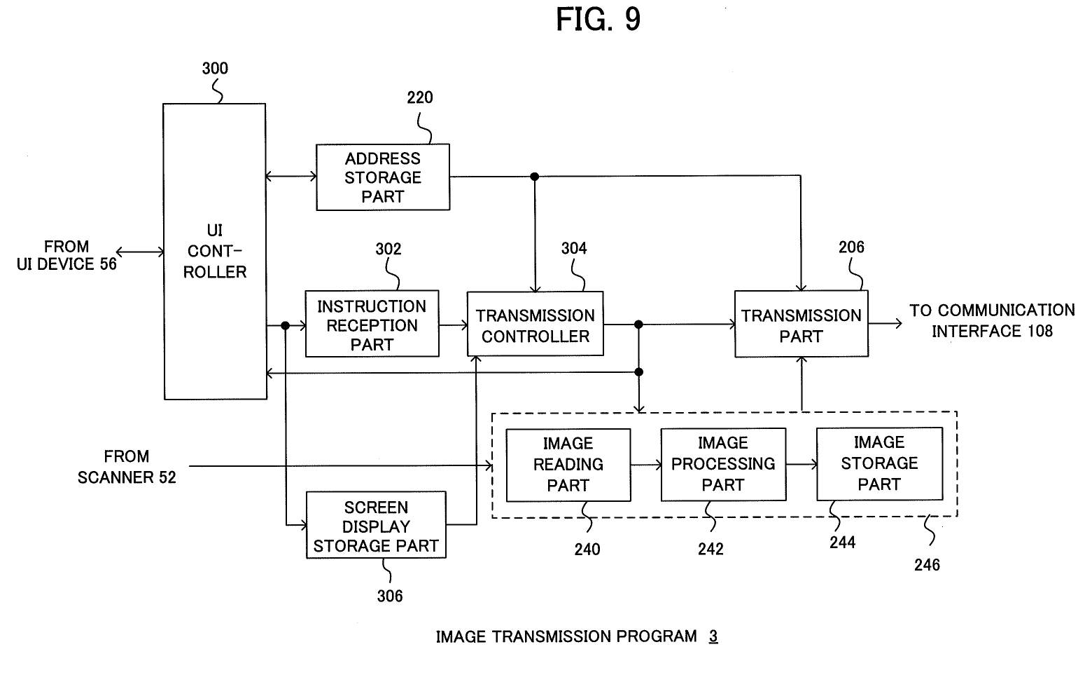

FIG. 9 is a view showing the constitution of the image transmissionprogram 3 executed by the transmission and reception device 10 in place of the image transmission program 2.

As shown in FIG. 9, the image transmission program 3 is constituted such that the UI controller 200, the instruction reception part 202 and the transmission controller 204 of the image transmission program 2 are respectively replaced with an UI controller 300, an instruction reception part 302 and a transmission controller 304, and a screen display storage part 306 is added to the image transmission program 3.

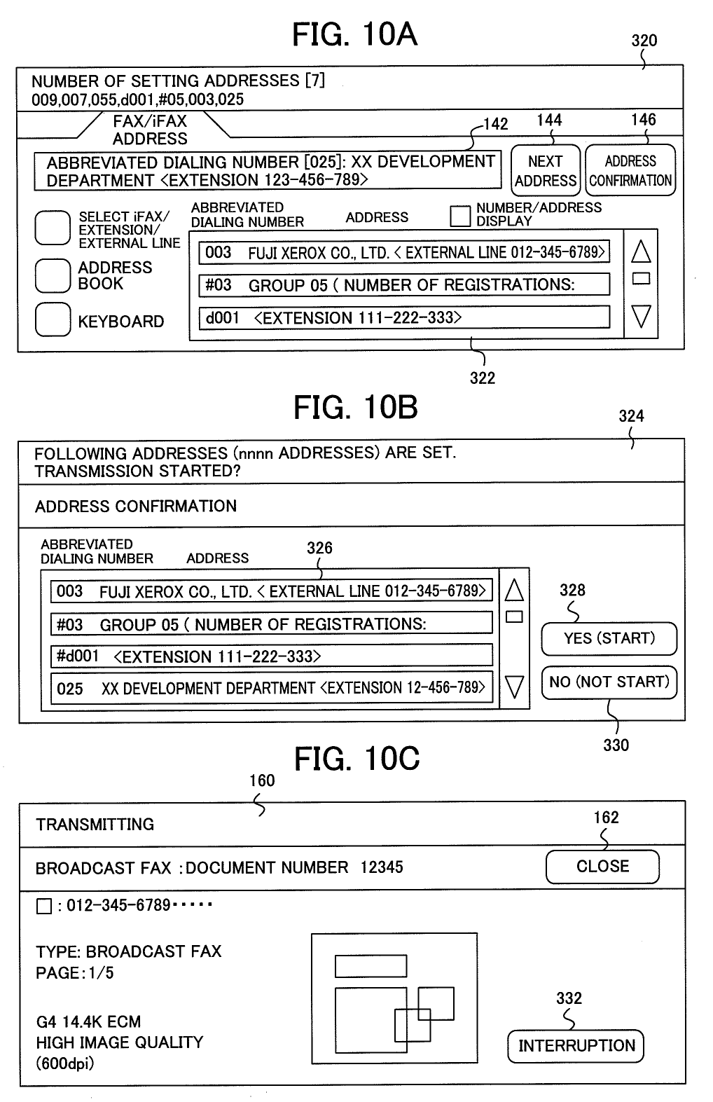

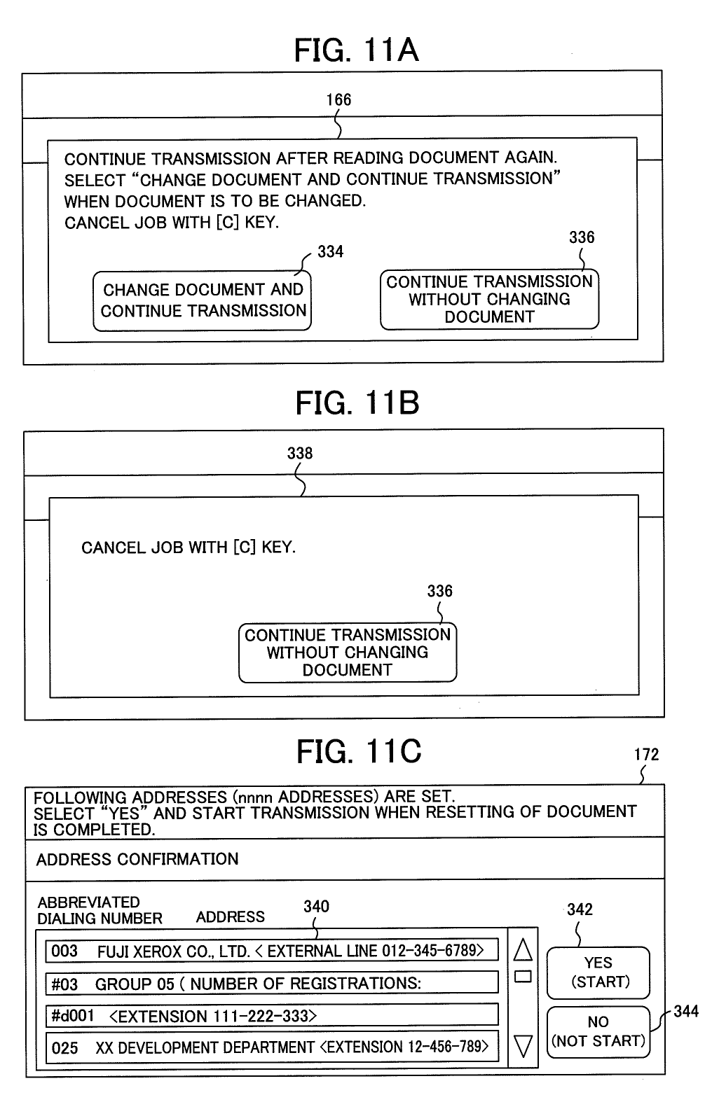

The UI controller 300 displays the address confirmation input screen shown in FIG. 6B and a screen described later in conjunction with FIG. 10 and FIG. 11 on the screen display 120 (FIG. 4).

First of all, the screen displayed on the screen display 120 by the UI controller 300 is explained in conjunction with FIGS. 10A to 11C.

FIG. 10A to FIG. 10C are views showing screens displayed on the image display 120 of the UI device 56 (FIG. 4), wherein FIG. 10A shows an address input screen in which plural addresses is set, FIG. 10B shows an address confirmation screen before transmission (address confirmation display), and FIG. 10C shows a transmission screen.

FIG. 11A to FIG. 11C are views showing screens displayed on the image display 120, wherein FIG. 11A shows an interruption screen displayed when the address confirmation screen shown in FIG. 10B is displayed before the transmission and an interruption button shown in FIG. 10C is pushed, FIG. 11B shows an interruption screen which is displayed when the address confirmation screen shown in FIG. 10B is not displayed before the transmission and the interruption button shown in FIG. 10C is pushed, and FIG. 11C shows a screen which is displayed when a document change button shown in FIG. 11A is pushed (after-document-change address confirmation screen).

As shown in FIG. 10A, the address input screen includes a status display region 320, an address display region 142, a next address button 144, an address confirmation input button 146, a plural address display region 322 and the like.

The status display region 320 indicates that the display screen is the address input screen, and indicates that plural different addresses is set.

The plural address display region 322 displays plural different addresses inputted by the user.

As shown in FIG. 10B, the address confirmation screen before transmission includes a status display region 324, an address confirmation region 326, a start button 328, a cancellation button 330 and the like.

The status display region 324 indicates that the display screen is the address confirmation screen before transmission.

The address confirmation region 326 displays plural different addresses inputted by the user.

The transmission is started when the user pushes the start button 328.

When the user pushes the cancellation button 330, the transmission is canceled, and the screen is shifted to the address input screen shown in FIG. 10A.

As shown in FIG. 10C, the transmission screen includes a status display region 160, a closing button 162, an interruption button 332 and the like.

When the user pushes the interruption button 332, the screen is shifted to the interruption screen shown in FIG. 11A or the interruption screen shown in FIG. 11B.

As shown in FIG. 11A, the interruption screen includes a status display region 166, a document change button 334, a continuation button 336 and the like.

When the user pushes the document change button 334, the screen is shifted to the after-document-change address confirmation screen shown in FIG. 11C.

The continuation button 336 is a button for continuing the transmission. When the user pushes the continuation button 336, the transmission is restarted from a point of time that the transmission is interrupted, and the screen is shifted to the transmission screen shown in FIG. 10C.

As shown in FIG. 11B, the interruption screen includes a status display region 338, a continuation button 336 and the like.

The status display region 338 indicates that the display screen is the interruption screen, and displays instructions for the user.

As shown in FIG. 11C, the after-document-change address confirmation screen includes a status display region 172, an address confirmation region 340, a start button 342, a cancellation button 344 and the like.

The address confirmation region 340 displays plural different addresses inputted by the user.

When the start button 342 is pushed after the document is changed by the user, the document is read again so that the transmission is continued and the screen is shifted to the transmission screen shown in FIG. 10C.

When the user pushes the cancel button 344, the screen is shifted to the interruption screen shown in FIG. 11A.

The UI controller 300 displays screens shown in FIG. 6B, FIGS. 10A, 10B, 10C and FIGS. 11A, 11B, 11C on the screen display 120 (FIG. 4) of the UI device 56.

Further, the UI controller 300 outputs the address inputted via the UI device 56 to the address storage part 220.

Further, the UI controller 300 outputs an operation instruction inputted from the group of operation buttons 122 of the UI device 56, the touch panel of the screen display 120 and the like to the instruction reception part 302.

Further, the UI controller 300 displays a screen based on control by the transmission controller 304 on the UI device 56.

To be more specific, the UI controller 300 performs processing substantially equal to processing which the UI controller 200 applies to the address input screen shown in FIG. 6A, to the address input screen shown in FIG. 10A.

That is, the address input screen shown in FIG. 10A differs from the address input screen shown in FIG. 6A only with respect to a point that plural different addresses is set.

Further, the UI controller 300 performs processing substantially equal to the processing which the UI controller 200 applies to the confirmation-use address input screen shown in FIG. 6B.

When the user pushes the start button from the operation buttons 122 shown in FIG. 4, the UI controller 300 outputs the received transmission instruction to the instruction reception part 302 and displays the address confirmation screen before transmission shown in FIG. 10B or the transmission screen shown in FIG. 10C based on control by the transmission controller 304.

When the user pushes the start button 328 shown in FIG. 10B, the UI controller 300 outputs the transmission instruction executed after confirmation of the received address (after-address-confirmation transmission instruction) to the instruction reception part 302, outputs information indicative of starting of the display by the address confirmation screen (FIG. 10B) to the screen display storage part 306 and displays the transmission screen shown in FIG. 10C.

When the user pushes the cancellation button 330 shown in FIG. 10B, the UI controller 300 displays the address input screen shown in FIG. 10A.

Further, when the user pushes the interruption button 332 of the transmission screen shown in FIG. 10C, the UI controller 300 outputs the received operation interruption instruction to the instruction reception part 302 and displays the interruption screen shown in FIG. 11A or FIG. 11B based on control executed by the transmission controller 304.

When the user pushes the document change button 334 shown in FIG. 11A, the UI controller 300 displays the after-document-change address confirmation screen shown in FIG. 11C.

When the user pushes the continuation button shown in FIGS. 11A, 11B, the UI controller 300 outputs an instruction indicative of the continuation of the transmission (continuation instruction) to the instruction reception part 302 and displays the transmission screen shown in FIG. 10C.

When the user pushes a (C) key on the interruption screen shown in FIG. 11A, 11B, the UI controller 300 outputs an instruction (cancellation instruction) indicative of cancellation of the transmission to the instruction reception part 302.

When the user pushes the start button 342 on the after-document-change address confirmation screen shown in FIG. 11C, the UI controller 300 outputs an instruction of confirmation of transmission after changing a received document (after-document-change continuation instruction) to the instruction reception part 302 and displays the transmission screen shown in FIG. 10C.

When the user pushes the cancellation button 344 shown in FIG. 11C, the UI controller 300 displays the interruption screen shown in FIG. 11A.

The instruction reception part 302 outputs the instruction inputted from the UI controller 300 to the transmission controller 304.

To be more specific, to the transmission controller 304, the instruction reception part 302 outputs a transmission start instruction which is inputted when the start button (FIG. 4) is pushed, an after-address-confirmation transmission instruction which is inputted when the start button 328 (FIG. 10B) is pushed, an interruption instruction which is inputted when the interruption button 332 (FIG. 10C) is pushed, a continuation instruction inputted when the continuation button 336 (FIGS. 11A, 11B) is pushed, a cancellation instruction which is inputted when the (C) key (FIGS. 11A, 11B) is pushed and an after-document-change continuation instruction which is inputted when the start button 342 (FIG. 11C) is pushed.

The transmission controller 304 controls the transmission part 206 and the image management part 246 in response to the instruction inputted from the instruction reception part 302.

To be more specific, when the transmission start instruction is inputted, the transmission controller 304 confirms whether or not plural different address information pieces are stored in the address storage part 220. When the plural different address information pieces are stored in the address storage part 220, the transmission controller 304 displays the before transmission address confirmation screen shown in FIG. 10B, while when the plural different address information pieces are not stored in the address storage part 220, the transmission controller 304 allows the image management part 246 to start the reading of an image, allows the transmission part 206 to start the transmission and allows the UI controller 300 to display the transmission screen (FIG. 10C).

When the after-address-confirmation transmission instruction is inputted, the transmission controller 304 allows the image management part 246 to start the reading of an image, allows the transmission part 206 to start the transmission and allows the UI controller 300 to display the transmission screen (FIG. 10C).

When the interruption instruction is inputted, the transmission controller 304 allows the image management part 246 to interrupt the reading of the image and allows the transmission part 206 to interrupt the transmission.

When the interruption instruction is inputted, the transmission controller 304 determines whether or not the image display storage part 306 stores the address confirmation screen display start information. When it is determined that the address confirmation screen display start information is stored in the image display storage part 306, the transmission controller 304 allows the UI controller 300 to display the interruption screen shown in FIG. 11A on the screen display 120, while when it is determined that the address confirmation screen display start information is not stored in the image display storage part 306, the transmission controller 304 allows the UI controller 300 to display the interruption screen shown in FIG. 11B on the screen display 120.

When the after-document-change continuation instruction is inputted, the transmission controller 304 allows the image management part 246 to start the reading of an image after performing the initializing processing and allows the transmission part 206 to start the transmission.

When the continuation instruction is inputted, the transmission controller 304 allows the image management part 246 to start the reading of the image again and the transmission part 206 to start the transmission again.

When the cancellation instruction is inputted, the transmission controller 304 allows the image transmission program 3 to perform the initializing processing.

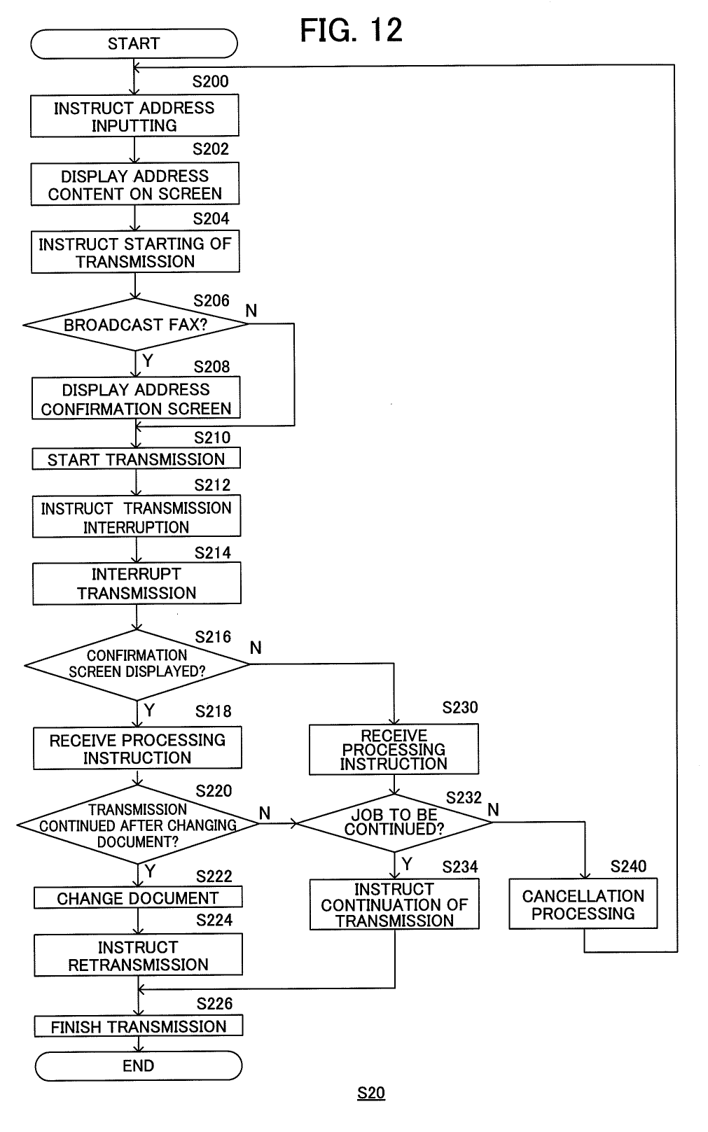

The processing of the image transmission program 3 described above is further explained in conjunction with FIG. 12.

FIG. 12 is a flowchart showing the processing of the image transmission program 3 (S20).

As shown in FIG. 12, in step 200 (S200), the UI controller 300 displays the address input screen shown in FIG. 10A so as to ask the user to input an address.

In step 202 (S202), the UI controller 300 displays the address inputted by the user on the address display region 142 or the plural address display region 322 (FIG. 10A).

In step 204 (S204), the transmission controller 304 receives a transmission start instruction inputted when the user pushes the start button from the group of the operation buttons 122.

In step 206 (S206), the transmission controller 304 determines whether or not plural different address information pieces are stored in the address storage part 220.

When it is determined that the plural address information pieces are stored in the address storage part 220, the processing advances to step S208, while when it is determined that the plural address information pieces are not stored in the address storage part 220, the processing advances to step S210.

In step 208 (S208), the transmission controller 304 allows the UI controller 300 to display the before transmission address confirmation screen (FIG. 10B) on the screen display 120 (FIG. 4).

In step 210 (S210), the transmission controller 304 allows the image management part 246 to start the reading of an image and allows the transmission part 206 to start the transmission.

In step 212 (S212), the transmission controller 304 receives the interruption instruction byway of the transmission screen shown in FIG. 10C.

In step 214 (S214), the transmission controller 304 allows the image management part 246 to interrupt the reading of the image and allows the transmission part 206 to interrupt the transmission.

In step 216 (S216), the transmission controller 304 determines whether or not the address confirmation screen start information is stored in the screen display storage part 306.

When it is determined that the address confirmation screen start information is stored in the screen display storage part 306, the processing advances to step S218, while when it is determined that the address confirmation screen start information is not stored in the screen display storage part 306, the processing advances to step S230.

In step 218 (S218), the transmission controller 304 receives an after-document-change continuation instruction, a continuation instruction or a cancellation instruction by way of the interruption screen shown in FIG. 11A or the address confirmation screen shown in FIG. 11C.

In step 220 (S220), the transmission controller 304 determines whether or not the received instruction is the after-document-change continuation instruction.

When it is determined that the received instruction is the after-document-change continuation instruction, the processing advances to step S222, while when it is determined that the received instruction is not the after-document-change continuation instruction, the processing advances to step S232.

In step 222 (S222), the transmission controller 304 allows the image management part 246 to perform the initializing processing and, thereafter, to start the reading of the image.

In step 224 (S224), the transmission controller 304 allows the transmission part 206 to start the transmission.

In step 226 (S226), the image transmission program 3 finishes the transmission processing.

In step 230 (S230), the transmission controller 304 receives a continuation instruction or a cancellation instruction by way of the interruption screen shown in FIG. 11B.

In step 232 (S232), the transmission controller 304 determines whether or not the received instruction is the continuation instruction.

When it is determined that the received instruction is the continuation instruction, the processing advances to step S234, while when it is determined that the received instruction is not the continuation instruction, the processing advances to step S240.

In step 234 (S234), the transmission controller 304 allows the image management part 246 to start the reading of an image again and allows the transmission part 206 to start the transmission again.

In step 240 (S240), the transmission controller 304 allows the image transmission program 3 to perform the initializing processing.

### Third Exemplary Embodiment

An image transmission program 4 is explained hereinafter as a third exemplary embodiment of the present invention.

[Image transmission program 4]

The image transmission program 4 is explained hereinafter.

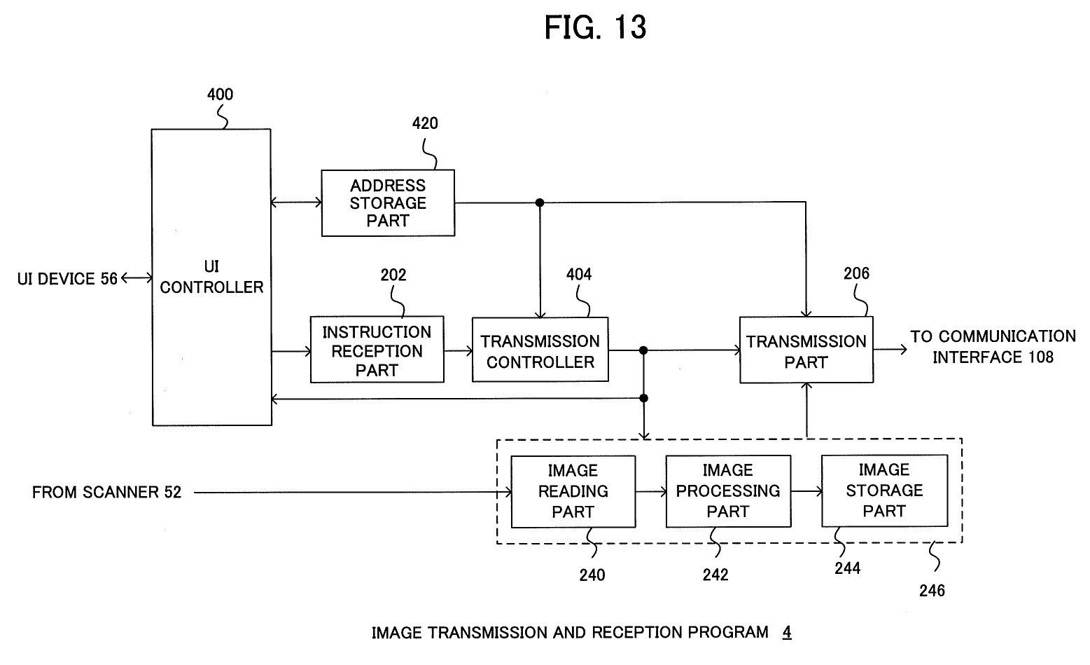

FIG. 13 is a view showing the constitution of the image transmission program 4 performed in place of the image transmission program 2 in the image transmission and reception apparatus 10.

As shown in FIG. 13, the image transmission program 4 has the constitution in which the UI controller 200 is replaced with a UI controller 400, the transmission controller 204 is replaced with a transmission controller 404 and the address storage part 220 is replaced with an address storage part 420.

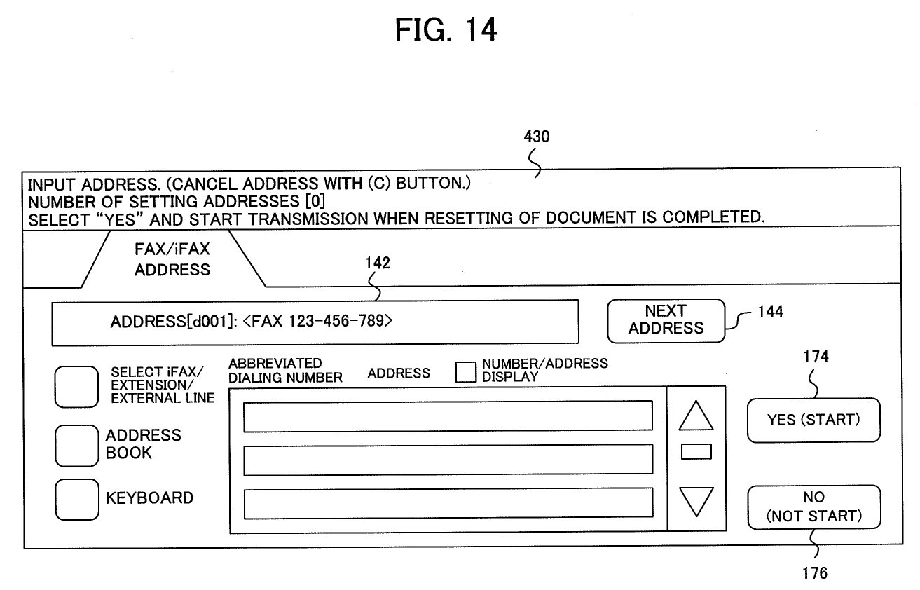

FIG. 14 is an after-document-change address input screen (address confirmation reception unit) which the UI controller 400 displays on the image display 120 (FIG. 4) in place of the after-document-change address confirmation screen shown in FIG. 7C.

As shown in FIG. 14, the after-document-change address input screen includes a status display region 430, an address display region 142, a next address button 144, a start button 174 and a cancellation button 176 and the like.

The status display region 430 indicates that a display screen is the after-document-change address input screen, and also displays an instruction for the user.

The address storage part 420 stores, in addition to the address information/confirmation-use address information which is stored in the address storage part 220, a unit by which the address is inputted (address input unit) and after-document-change address information described later.

To be more specific, the address is inputted from the numeric keypad (dial) or an abbreviated dialing button among the group of operation buttons 122 shown in FIG. 4 and hence, the address storage part 420 stores the inputted address information and the address input unit in a mutually associated manner.

Functions of the UI controller 400 are improved with respect to following points compared to the functions of the UI controller 200.

When the user pushes the cancellation button 164 of the transmission screen shown in FIG. 7A, the UI controller 400 confirms the confirmation-use address information stored in the address storing part 420. When the confirmation-use address information is not stored, a masked screen which prevents the selection of the document change button 168 is displayed in the interruption screen shown in FIG. 7B.

Further, when the address storage part 420 stores the confirmation-use address information, the UI controller 400 displays the interruption screen shown in FIG. 7B.

Further, when the user pushes the document change button 168 shown in FIG. 7B, the UI controller 400 displays the after-document-change address input screen shown in FIG. 14 and asks the user to input the address again.

Further, the UI controller 400 outputs the address inputted by the user on the after-document-change address input screen shown in FIG. 14 (after-document-change address information) to the address storage part 420.

Functions of the transmission controller 404 are improved with respect to following points compared to functions of the transmission controller 204.

When the transmission start instruction is inputted, the transmission controller 404 confirms the address input unit stored in the address storage part 420. When it is determined that the address is inputted from the dial, only when the confirmation-use address information is stored, the transmission controller 404 allows the image management part 246 to start the reading of an image and allows the transmission part 206 to start the transmission, while when the confirmation-use address information is not stored, the transmission controller 404 allows the UI controller 400 to display the address input screen (FIG. 6A).

Further, when the address is inputted from the abbreviated dialing button, even when the confirmation-use address information is not stored, the transmission controller 404 allows the image management part 246 to start the reading of the image and allows the transmission part 206 to start the transmission.

Further, when the after-document-change continuation instruction is inputted, the transmission controller 404 determines whether or not the address information stored in the address storage part 420 agrees with the after-document-change address information. When it is determined that the address information stored in the address storage part 420 agrees with the after-document-change address information, the transmission controller 404 allows the image management part 246 to perform the initializing processing and, thereafter, to start the reading of the image and allows the transmission part 206 to start the transmission. When the address information stored in the address storage part 420 does not agree with the after-document-change address information, the transmission controller 404 displays the after-document-change address input screen shown in FIG. 14.

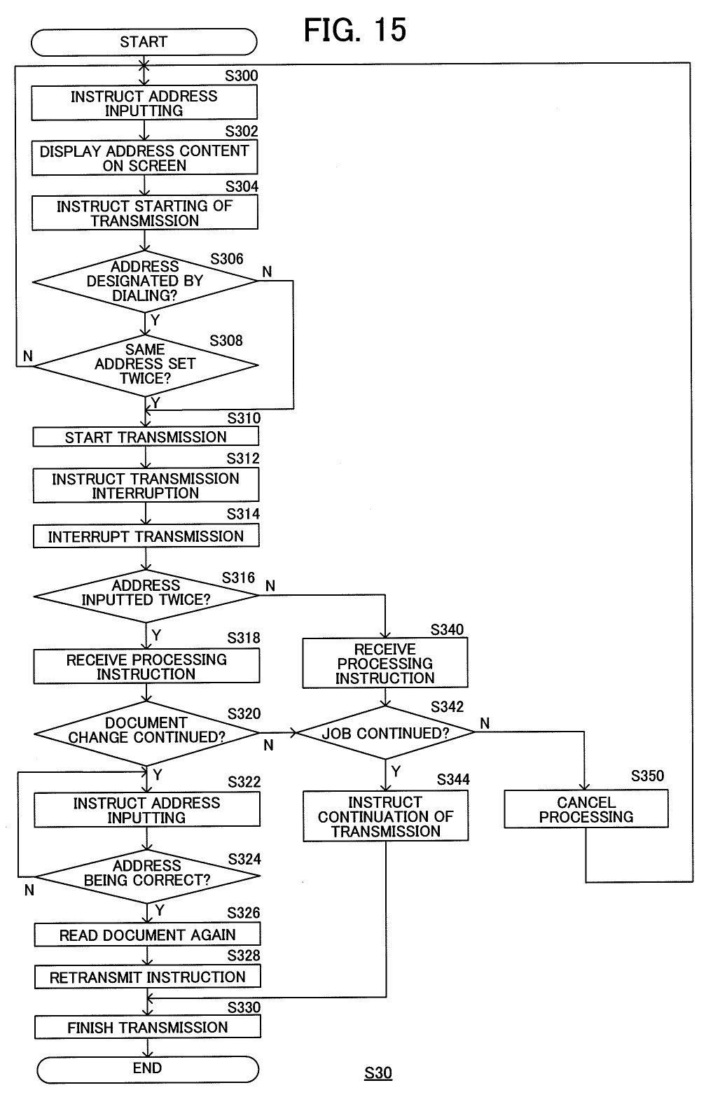

The processing of the image transmission program 4 explained above is further explained in conjunction with FIG. 15.

FIG. 15 is a flowchart showing the processing of the image transmission program 4 (S30).

As shown in FIG. 15, in step 300 (S300), the UI controller 400 displays the address input screen shown in FIG. 6A and asks the user to input an address.

In step 302 (S302), the UI controller 400 displays the address inputted by the user to the address display region 142 (FIG. 6A).

In step 304 (S304), the transmission controller 404 receives the transmission start instruction which is inputted when the user pushes the start button from a group of operation buttons 122.

In step 306 (S306), the transmission controller 404 confirms the address input unit stored in the address storage part 420 and determines whether or not the address is inputted from by dialing.

When the address is inputted by dialing, the processing advances to step S308, while when the address is not inputted by dialing, the processing advances to step S310.

In step 308 (S308), the transmission controller 404 determines whether or not the address information and the confirmation-use address information are stored in the address storage part 420.

When it is determined that the address information and the confirmation-use address information are stored in the address storage part 420, the processing advances to step S310, while when it is determined that the address information and the confirmation-use address information are not stored in the address storage part 420, the processing returns to step S300.

Instep 310 (S310), the transmission controller 404 allows the image management part 246 to start the reading of the image and allows the transmission part 206 to start the transmission.

In step 312 (S312), the transmission controller 404 receives the interruption instruction byway of the transmission screen shown in FIG. 7A.

Instep 314 (S314), the transmission controller 404 allows the image management part 246 to interrupt the reading of the image and allows the transmission part 206 to interrupt the transmission.

In step 316 (S316), the transmission controller 404 determines whether or not the address information and the confirmation-use address information are stored in the address storage part 420.

When it is determined that the address information and the confirmation-use address information are stored in the address storage part 420, the processing advances to step S318, while when it is determined that the address information and the confirmation-use address information are not stored in the address storage part 420, the processing advances to step S340.

In step 318 (S318), the UI controller 400 receives operation by the user by way of the interruption screen shown in FIG. 7B.

In step 320 (S320), the UI controller 400 determines whether or not the document change button 168 is pushed.

When the document change button 168 is pushed, the processing advances to step S322, while when the document change button 168 is not pushed, the processing advances to step S342.

In step 322 (S322), the UI controller 400 displays the address input screen shown in FIG. 14 and asks the user to input an address and to instruct after-document-change continuation instruction.

In step 324 (S324), the transmission controller 404 determines whether or not the address information stored in the address storage part 420 agrees with the after-document-change address information.

When it is determined that the address information stored in the address storage part 420 agrees with the after-document-change address information, the processing advances to step S326, while when the address information stored in the address storage part 420 does not agree with the after-document-change address information, the processing advances to step S322.

Instep 326 (S326), the transmission controller 404 allows the image management part 246 to perform the initializing processing and, thereafter, to start the reading of an image.

In step 328 (S328), the transmission controller 404 allows the transmission part 206 to start the transmission.

In step 330 (S330), the image transmission program 4 finishes the transmission processing.

In step 340 (S340), the transmission controller 404 receives the continuation instruction or the cancellation instruction by way of the screen in which the document change button 168 is masked in the interruption screen shown in FIG. 7B.

In step 342 (S342), the transmission controller 404 determines whether or not the received instruction is the continuation instruction.

When the received instruction is the continuation instruction, the processing advances to step S344, while when the received instruction is not the continuation instruction, the processing advances to step S350.

Instep 344 (S344), the transmission controller 404 allows the image management part 246 to start the reading of the image again and allows the transmission part 206 to start the transmission.

In step 350 (S350), the transmission controller 404 allows the image transmission program 4 to perform the initializing processing.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image transmission apparatus comprising:
an address instruction unit that is configured to instruct an address of a destination;
a transmission interruption instruction unit that is configured to, after transmission to the address of the destination instructed by the address instruction unit is instructed, instruct interruption of the transmission; and
a retransmission instruction unit that is configured to, when the transmission is instructed to be interruption by the transmission interruption instruction unit, instruct transmission of a newly fetched image in a state that the address instructed by the address instruction unit is maintained.

2. The image transmission apparatus according to claim 1, wherein the address instruction unit further includes an address reception unit that receives an address to be instructed, and an address confirmation reception unit that receives an address to be confirmed, and
the retransmission instruction unit instructs transmission when the address received by the address reception unit and the address received by the address confirmation reception unit are equal to each other.

3. The image transmission apparatus according to claim 2, wherein the address confirmation reception unit receives the address to be confirmed when the address reception unit receives the address due to pushing of a button that is associated with numerals.

4. The image transmission apparatus according to claim 1, wherein the address instruction unit further includes an address reception unit that receives an address to be instructed, and an address confirmation reception unit that receives an address to be confirmed when a transmission interruption state is instructed by the transmission interruption instruction unit, and
the retransmission instruction unit instructs transmission when the address received by the address reception unit and the address received by the address confirmation reception unit are equal to each other.

5. The image transmission apparatus according to claim 1, further having:
an address confirmation display that displays an address of a destination to be confirmed before transmission to the address of the destination instructed by the address instruction unit is instructed,
wherein the retransmission instruction unit instructs transmission when the address confirmation display displays the address of the destination to be confirmed.

6. The image transmission apparatus according to claim 5, wherein the address confirmation display displays the addresses of the destinations to be confirmed when the addresses of the destinations instructed by the address instruction unit includes a plurality of different addresses.

7. A facsimile device comprising:
an image reading unit that is configured to read an image;
an address instruction unit that is configured to instruct an address of a destination;
a transmission interruption instruction unit that is configured to, after transmission of an image read by the image reading unit is instructed to the address of the destination instructed by the address instruction unit, instruct interruption of the transmission; and
a retransmission instruction unit that is configured to, when the transmission is instructed to be interruption by the transmission interruption instruction unit, instruct transmission of an image that is newly fetched by the image reading unit in a state that the address instructed by the address instruction unit is maintained.

8. A computer readable medium storing a program causing a computer of an image transmission apparatus to execute a process comprising:
instructing an address of a destination;
instructing interruption of a first transmission after instructing the first transmission to the address of the destination; and
instructing a second transmission of a newly fetched image in a state that the instructed address is maintained when the first transmission is instructed to be interruption.

9. An image transmission method, comprising:
instructing an address of a destination;
instructing interruption of a first transmission after instructing the first transmission to the address of the destination; and
instructing a second transmission of a newly fetched image in a state that the instructed address is maintained when the first transmission is instructed to be interruption.

10. A computer data signal embodied in a carrier wave for enabling a computer to perform a process for an image transmission, the process comprising:
instructing an address of a destination;
instructing interruption of a first transmission after instructing the first transmission to the address of the destination; and
instructing a second transmission of a newly fetched image in a state that the instructed address is maintained when the first transmission is instructed to be interruption.
